(19) United States
(12) Patent Application Publication
(10) Pub. No.: US 2026/0034440 A1
(43) Pub. Date: Feb. 5, 2026

(54) CLOUD GAME OPERATION CONTROL METHOD AND COMPUTER DEVICE

(71) Applicant: Beijing Zitiao Network Technology Co., Ltd., Beijing (CN)

(72) Inventor: Pude ZHOU, Beijing (CN)

(21) Appl. No.: 19/099,763

(22) PCT Filed: Apr. 25, 2024
(86) PCT No.: PCT/CN2024/089738

§ 371 Date: Jan. 29, 2025

(30) Foreign Application Priority Data
Jun. 20, 2023 (CN) 202310736086.3

(51) Int. Cl. A63F 13/45; A63F 13/355; A63F 13/52

(52) U.S. Cl. CPC A63F 13/45; A63F 13/355; A63F 13/52

(57) ABSTRACT

A cloud game operation control method and a computer device are provided. The method includes: determining game state information of a target cloud game currently running in a cloud game client; determining, based on the game state information, at least one operation instruction set matching the game state information, and indicating the at least one operation instruction set to the cloud game client, wherein the operation instruction set is obtained by performing operation instruction recognition processing based on a target game video matching the game state information; and in response to receiving a selected target operation instruction set fed back by the cloud game client, generating game image data obtained after the cloud game client correspondingly executes the target operation instruction set, and sending the game image data to the cloud game client.

This application claims the priority to and benefits of the Chinese Patent Application No. 202310736086.3, which was filed on Jun. 20, 2023. The aforementioned Chinese patent application is hereby incorporated by citation in its entirety as part of the present application.

### TECHNICAL FIELD

The present disclosure relates to a cloud game operation control method and apparatus, a computer device, and a storage medium.

### BACKGROUND

In a game process, gamers may face different game tasks. For some gamers such as novice players inexperienced in games, if they want to complete the game, they can only make attempts one by one in the game to pass the game in a manner of selecting different operation instructions for many times. In this way, the gamers need to repetitively play the game for many times, and spend lots of time to pass the game, resulting in poor interactive experience.

Therefore, how to reduce interactive trial-and-error costs when the players normally perform game interaction to improve interactive experience is a problem worthy of research.

### SUMMARY

Embodiments of the present disclosure provide at least a cloud game operation control method and apparatus, a computer device, and a storage medium.

In a first aspect, an embodiment of the present disclosure provides a cloud game operation control method, which is applicable to a cloud game platform, the method comprising: A cloud game operation control method, applicable to a cloud game platform, and comprising: determining game state information of a target cloud game currently running in a cloud game client; determining, based on the game state information, at least one operation instruction set matching the game state information, and indicating the at least one operation instruction set to the cloud game client, the operation instruction set being obtained by performing operation instruction recognition processing based on a target game video matching the game state information, and the target game video being a game operation video, a corresponding game operation result of which meets a target condition; and in response to receiving a selected target operation instruction set fed back by the cloud game client, generating game image data obtained after the cloud game client correspondingly executes the target operation instruction set, and sending the game image data to the cloud game client.

In an alternative embodiment, the operation instruction set is obtained by performing the operation instruction recognition processing on the target game video in the following manner: filtering in the target game video to obtain a plurality of key frames comprising a virtual game object; performing semantic recognition processing on the plurality of key frames, to determine object behavior information of the virtual game object; and generating the operation instruction set based on the object behavior information.

In an alternative embodiment, the method further comprises: after obtaining a plurality of operation instruction sets based on a plurality of target game videos, generating label information corresponding to each operation instruction set according to game-related data in the target game video; and the indicating the at least one operation instruction set to the cloud game client comprises: indicating the plurality of operation instruction sets and label information respectively corresponding to the plurality of operation instruction sets to the cloud game client.

In an alternative embodiment, the indicating the plurality of operation instruction sets and label information respectively corresponding to the plurality of operation instruction sets to the cloud game client comprises: determining correlation scores respectively between the plurality of operation instruction sets and the game state information of the cloud game client according to the label information of the plurality of operation instruction sets; determining operation result scores of the plurality of operation instruction sets according to the label information of the plurality of operation instruction sets; and sorting the plurality of operation instruction sets according to the correlation scores and the operation result scores, and indicating the plurality of sorted operation instruction sets and the label information respectively corresponding to the plurality of operation instruction sets to the cloud game client.

In a second aspect, an embodiment of the present disclosure provides a cloud game operation control method, applicable to a cloud game client, and comprising: displaying a game battle interface of a target cloud game; displaying at least one operation instruction set matching current game state information of the game battle, the operation instruction set being obtained by performing operation instruction recognition processing based on a target game video matching the game state information; in response to selecting a target operation instruction set in the at least one operation instruction set, determining the target operation instruction set; and receiving game image data obtained after the target operation instruction set is executed, and displaying a current game image based on the game image data.

In an alternative embodiment, the operation instruction set is generated by using object behavior information of a virtual game object obtained through recognition after semantic recognition is performed on a plurality of key frames of the virtual game object included in the target game video; and the target game video is a game operation video, a corresponding game operation result of which meets a target condition.

In an alternative embodiment, the displaying at least one operation instruction set matching current game state information of a game battle comprises: displaying the at least one operation instruction set, and label information corresponding to each operation instruction set, wherein the label information indicates game attribute information corresponding to the operation instruction set, and the game attribute information is used by a user for reference to select the target operation instruction set.

In an alternative embodiment, after the displaying the at least one operation instruction set, the method further comprises: in response to a preview instruction for any operation instruction set, obtaining preview image data fed back in response to the preview instruction; and displaying, outside a current game image, a game preview image corresponding to the preview image data.

In an alternative embodiment, after the displaying the at least one operation instruction set, the method further comprises: in response to a synchronous preview instruction for the plurality of operation instruction sets, obtaining preview image data separately generated in response to the synchronous preview instruction; and synchronously displaying, outside a current game image, game preview images respectively corresponding to the plurality of pieces of preview image data.

In an alternative embodiment, the preview image data is obtained according to the following steps: obtaining mixed flow image data obtained by performing flow mixing processing on the preview image data and current game image data; and displaying the game preview image, comprising: dividing a game display page into a plurality of display areas based on a quantity of game images corresponding to the mixed flow image data, and displaying the current game image and at least one of the game preview images respectively in the plurality of display areas.

In a third aspect, an embodiment of the present disclosure provides a cloud game operation control apparatus, applicable in a cloud game platform, and comprising: a first determining module. configured to determine game state information of a target cloud game currently running in a cloud game client; a first sending module, configured to: determine, based on the game state information, at least one operation instruction set matching the game state information, and indicate the at least one operation instruction set to the cloud game client, the operation instruction set being obtained by performing operation instruction recognition processing based on a target game video matching the game state information, and the target game video being a game operation video, a corresponding game operation result of which meets a target condition; and a second sending module, configured to: in response to receiving a selected target operation instruction set fed back by the cloud game client, generate game image data obtained after the cloud game client correspondingly executes the target operation instruction set, and send the game image data to the cloud game client.

In an alternative embodiment, the operation instruction set is obtained by performing the operation instruction recognition processing on the target game video in the following manner; filtering in the target game video to obtain a plurality of key frames including a virtual game object; performing semantic recognition processing on the plurality of key frames, to determine object behavior information of the virtual game object; and generating the operation instruction set based on the object behavior information.

In an alternative embodiment, the apparatus further includes a processing module, configured to: after obtaining a plurality of operation instruction sets based on a plurality of target game videos, generate label information corresponding to each operation instruction set according to game-related data in the target game video; and when indicating the at least one operation instruction set to the cloud game client, the first sending module is configured to indicate the plurality of operation instruction sets and label information respectively corresponding to the plurality of operation instruction sets to the cloud game client.

In an alternative embodiment, when indicating the plurality of operation instruction sets and label information respectively corresponding to the plurality of operation instruction sets to the cloud game client, the first sending module is configured to: determine correlation scores respectively between the plurality of operation instruction sets and the game state information of the cloud game client according to the label information of the plurality of operation instruction sets; determine operation result scores of the plurality of operation instruction sets according to the label information of the plurality of operation instruction sets; and sort the plurality of operation instruction sets according to the correlation scores and the operation result scores, and indicate the plurality of sorted operation instruction sets and the label information respectively corresponding to the plurality of operation instruction sets to the cloud game client.

In a fourth aspect, an embodiment of the present disclosure provides a cloud game operation control apparatus, applicable in a cloud game client, and comprising: a first display module, configured to display a game battle interface of a target cloud game; a second display module, configured to display at least one operation instruction set matching current game state information of a game battle, the operation instruction set being obtained by performing operation instruction recognition processing based on a target game video matching the game state information; a second determining module, configured to: in response to selecting a target operation instruction set in the at least one operation instruction set, determine the target operation instruction set; and a third display module, configured to: receive game image data obtained after the cloud game client executes the target operation instruction set, and display a current game image based on the game image data.

In an alternative embodiment, the operation instruction set is generated by using object behavior information of a virtual game object obtained through recognition after semantic recognition is performed on a plurality of key frames of the virtual game object included in the target game video; and the target game video is a game operation video, a corresponding game operation result of which meets a target condition.

In an alternative embodiment, when displaying the at least one operation instruction set matching the current game state information of the game battle, the first display module is configured to: display the at least one operation instruction set, and label information corresponding to each operation instruction set, where the label information indicates game attribute information corresponding to the operation instruction set, and the game attribute information is used by a user for reference to select the target operation instruction set.

In an alternative embodiment, after displaying the at least one operation instruction set, the second display module is further configured to: in response to a preview instruction for any operation instruction set, obtain preview image data fed back in response to the preview instruction; and display. outside a current game image, a game preview image corresponding to the preview image data.

In an alternative embodiment, after displaying the at least one operation instruction set, the second display module is further configured to: in response to a synchronous preview instruction for the plurality of operation instruction sets, obtain preview image data separately generated in response to the synchronous preview instruction; and synchronously display, outside a current game image, game preview images respectively corresponding to the plurality of pieces of preview image data.

In an alternative embodiment, the preview image data is obtained according to the following steps: obtaining mixed flow image data obtained by performing flow mixing processing on the preview image data and current game image data; and when displaying the game preview image, the second display module is configured to: divide a game display page into a plurality of display areas based on a quantity of game images corresponding to the mixed flow image data, and display the current game image and the at least one game preview image respectively in the plurality of display areas.

In a fifth aspect, an embodiment of the present disclosure provides a computer device, comprising: a processor and a memory, wherein the memory stores a machine-readable instruction that can be executed by the processor, the processor is configured to execute the machine-readable instruction stored in the memory, and when the machine-readable instruction is executed by the processor, the processor performs the cloud game operation control method according to any one of the first aspect or the second aspect.

In a sixth aspect, an embodiment of the present disclosure provides a computer-readable storage medium, wherein the computer-readable storage medium stores a computer program, and when the computer program is run by a computer device, the computer device performs the cloud game operation control method according to any one of the first aspect or the second aspect.

In order to make the above objects, features and advantages of the present disclosure more obvious and easier to understand, the following is a detailed description of preferred embodiments, with the attached drawings.

### BRIEF DESCRIPTION OF DRAWINGS

In order to more clearly illustrate the technical solutions in the embodiments of the present disclosure or the related art, the following briefly introduces the accompanying drawings required for describing the embodiments or the related art. The accompanying drawings, which are hereby incorporated in and constitute a part of the present description, illustrate embodiments of the present disclosure, and together with the description, serve to illustrate the technical solutions of the present disclosure. It should be understood that the accompanying drawings in the following description show merely some embodiments of the present disclosure. For an ordinary skilled in the art, other drawings can be obtained according to these drawings without creative work.

FIG. 1 is a schematic diagram of a cloud game system architecture according to an embodiment of the present disclosure;

FIG. 2 is a specific schematic structural diagram of a cloud game system according to an embodiment of the present disclosure;

FIG. 3 is a flowchart of a cloud game operation control method according to an embodiment of the present disclosure;

FIG. 4a is a schematic diagram of a plurality of displayed operation instruction sets according to an embodiment of the present disclosure;

FIG. 4b is another schematic diagram of a plurality of displayed operation instruction sets according to an embodiment of the present disclosure;

FIG. 5a is a schematic diagram of previewing a game preview image under one operation

instruction set according to an embodiment of the present disclosure;

FIG. 5b is a schematic diagram of previewing game preview images under a plurality of operation instruction sets according to an embodiment of the present disclosure;

FIG. 6 is a flowchart of another cloud game operation control method according to an embodiment of the present disclosure;

FIG. 7 is a schematic diagram of a cloud game operation control apparatus according to an embodiment of the present disclosure;

FIG. 8 is a schematic diagram of another cloud game operation control apparatus according to an embodiment of the present disclosure; and

FIG. 9 is a schematic diagram of a computer device according to an embodiment of the present disclosure.

### DETAILED DESCRIPTION

In order to make the purpose, technical solutions and advantages of the embodiments of the disclosure more clear, the technical solutions in the embodiments of the disclosure will be described clearly and completely with the drawings. Obviously, the described embodiments are only a part of the embodiments of the disclosure, but not all embodiments. Components of embodiments of the present disclosure generally described and illustrated herein may be arranged and designed in various different configurations. Therefore, the following detailed description of the embodiments of the present disclosure is not intended to limit the scope of the present disclosure, but merely represents selected embodiments of the disclosure. Based on the embodiments of the present disclosure, all other embodiments obtained by those skilled in the art without creative work belong to the scope of the present disclosure.

It is found through research that during a game, because a game task is of a particular game difficulty, for users who are inexperienced in the game such as novice players, if they want to complete the game, they need to select different operation instructions each time and make a plurality of attempts in the game to pass the game after completing various possible operation choices. This is poor interactive experience for gamers, who need to spend a lot of time selecting and combining different operation manners and playing the game repetitively.

Based on the foregoing research, the present disclosure provides a cloud game operation control method. A cloud game platform may provide, according to game state information when a target cloud game is currently run, an operation instruction set matching the current game state information for a cloud game client. Herein, the operation instruction set is obtained by performing operation instruction recognition processing according to a target game video matching the game state information. For example, when there is a historical game video in which another user passes the game in a similar game state, recognition processing may be performed on the historical game video, to obtain an operation instruction set selected when the game is completed. In this way, gamers may refer to and select these operation instruction sets that are expected to pass the game, to quickly complete the same, and do not need to select, by themselves, different operation instructions and making a plurality of game attempts repetitively, so as to reduce interactive trial-and-error costs when the gamers normally perform game interaction, thereby improving interactive experience.

The defects that exist in the foregoing solutions are all results of the inventor's practice and careful study. Therefore, the process of discovery of the foregoing problems and the solutions proposed in the present disclosure hereinafter for the foregoing problems should be the inventor's contribution to the present disclosure in the process of the present disclosure.

It should be noted that similar reference numerals and letters indicate similar items in the following accompanying drawings, so that once an item is defined in one accompanying drawing, it does not need to be further defined and explained in subsequent accompanying drawings.

For ease of understanding of embodiments, a cloud game operation control method disclosed in this embodiment of the present disclosure is first described in detail. An execution body of the cloud game operation control method provided in this embodiment of the present disclosure is generally a computer device having a particular computing capability. The computer device includes, for example, a terminal device, a server, or another processing device, and the terminal device may be user equipment (User Equipment (UE), a mobile device, a user terminal, a terminal, a cellular telephone, a cordless telephone, a personal digital assistant (PDA), a handheld device, a computing device, a vehicle-mounted device, a wearable device, or the like. In some possible implementations, the cloud game operation control method may be implemented by a processor by invoking a computer-readable instruction stored in a memory.

A cloud game involved in embodiments of the present disclosure is specifically an online game service that does not need to be downloaded and locally installed, so that a user can use, across ends, a game that is not locally installed when there is no game console. The user may access the cloud game platform by using a television, a computer, a mobile phone, or another device, and does not need to download or install a game, and the game can be run provided that a network connection is maintained, so that limitation of game content of different platforms can be broken through.

In embodiments of the present disclosure, a cloud game system architecture is first described briefly. FIG. 1 is a schematic diagram of a cloud game system architecture according to an embodiment of the present disclosure, and relates to a cloud game client 11, a cloud game platform 12, and a cloud game running end 13. The cloud game client 11 communicates with the cloud game platform 12, and the cloud game platform 12 communicates with the cloud game running end 13.

The following first briefly describes functions that can be implemented by the ends in the system.

For the cloud game client (a cloud game client SDK), a carrier thereof may be an application, a running platform, or the like that can run a cloud game. The cloud game client may provide a visual interface for a player, so that the player can play a cloud game on the visual interface. The cloud game client may establish a connection to the cloud game platform, transmit operation instructions selected by the user to the cloud game platform, and may also receive game image data that needs to be rendered and displayed to the player by the cloud game platform.

For the cloud game platform, the cloud game platform may specifically include the following modules: a transmission module, configured to separately connect to the cloud game client (the cloud game client SDK) and a cloud game toolkit (GameSDK) that is in the cloud game running end, to transmit game data and operation instructions: a control module, configured to control an operation permission of the player and integrate operation instructions uploaded by the player; a scheduling module, configured to install, delete, update, upload, and remove the cloud game to/from the cloud game running end; a permission management module, configured to obtain and verify a running permission of the cloud game client; a storage module, configured to store user data and game data of the player; and a configuration module, configured to provide a visual interface for configuring games and gameplay. In addition, the cloud game platform also includes a data processing module, such as an artificial intelligence (AI) module, configured to process data, information, and the like. In embodiments of the present disclosure, tasks include but are not limited to speech recognition, video analysis, label annotation, data sorting, and information combination tasks. Reference may be made to the following specific descriptions in embodiments of the present disclosure for details.

The cloud game running end is specifically a cloud game running end machine, and is used as an actual machine for running cloud games. The cloud game running end may establish a connection to the cloud game platform, transmit data to the cloud game platform, and execute operation instructions transmitted by the cloud game platform. The cloud game running end specifically includes a cloud game toolkit and a game processing logic. The cloud game running end toolkit is integrated in a cloud game, and executes interaction of related functions such as instruction uploading, maintenance, and replay in the cloud game, and executes interaction of related functions such as interaction uploading, maintenance, and replay with the cloud game platform.

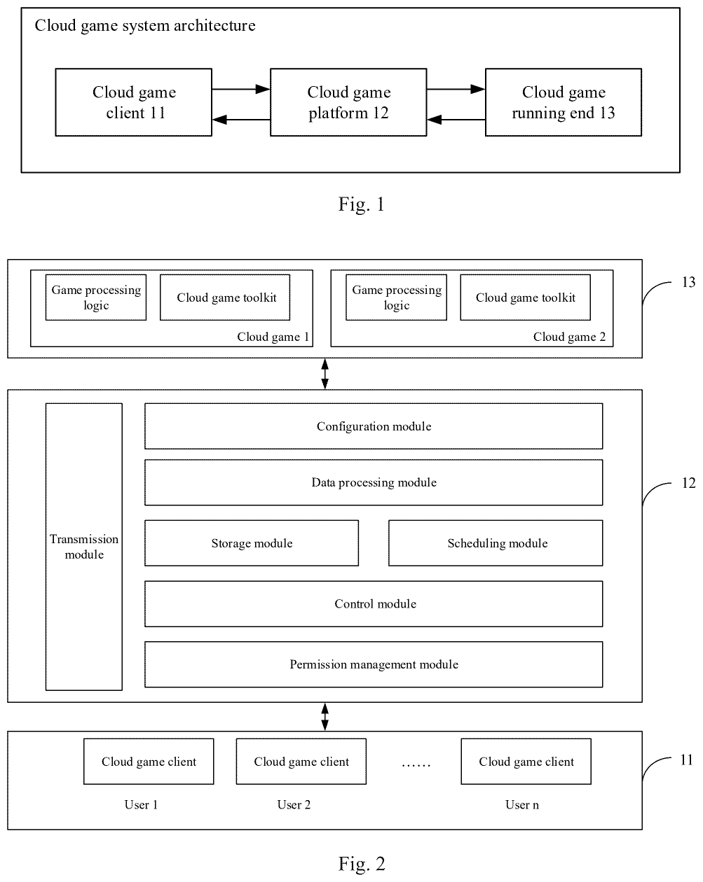

For the foregoing described cloud game client, cloud game platform, and cloud game running end in the system, a schematic structural diagram is shown in FIG. 2. Two different cloud games are listed in the cloud game running end. Under the cloud game client, a plurality of annotated cloud game clients corresponding to a user 1, a user 2, and the like are listed exemplarily.

The following describes a cloud game operation control method provided in embodiments of the present disclosure.

First, an example in which an execution body is the cloud game platform is used for description. Herein, the cloud game platform, independent of the cloud game client and the cloud game running end, implements an information transmission function. In addition, in a cloud game, the cloud game client receives an operation instruction triggered by a user, and displays a game image to the user, to complete interaction between the user and the cloud game, and the cloud game running end determines image data under the operation instruction, to complete running of the game. The cloud game platform may carry another operation of data processing, for example, operation instruction transmission, image data transmission, and the like, and may also include recommended operation instruction collation, operation instruction recognition in an image, and the like, to alleviate burden of tasks of the cloud game client and the cloud game running end.

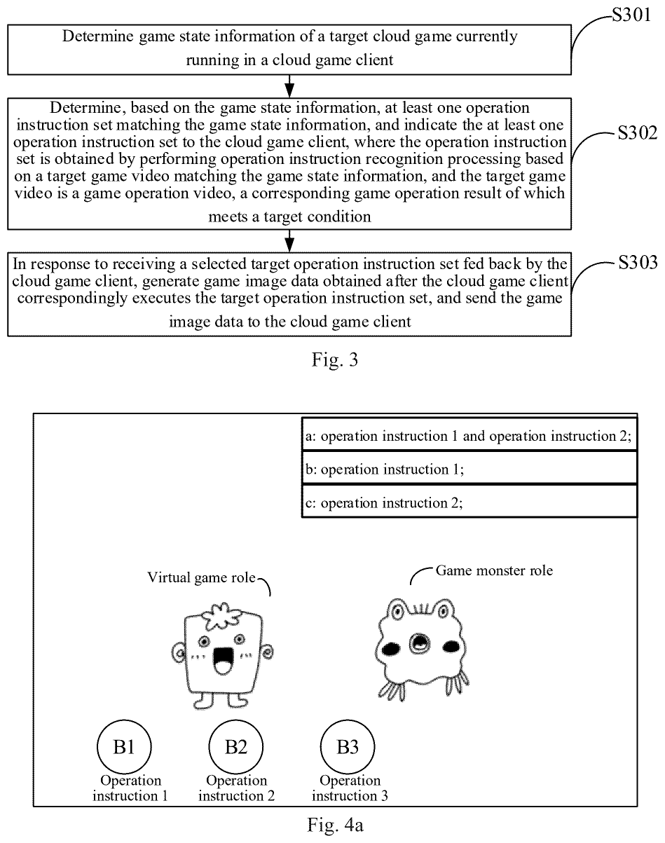

FIG. 3 is a flowchart of a cloud game operation control method according to an embodiment of the present disclosure. The method includes steps S301 to S303.
S301: Determine game state information of a target cloud game currently running in a cloud game client.
S302: Determine, based on the game state information, at least one operation instruction set matching the game state information, and indicate the at least one operation instruction set to the cloud game client, where the operation instruction set is obtained by performing operation instruction recognition processing based on a target game video matching the game state information, and the target game video is a game operation video, a corresponding game operation result of which meets a target condition.
S303: In response to receiving a selected target operation instruction set fed back by the cloud game client, generate game image data obtained after the cloud game client correspondingly executes the target operation instruction set, and send the game image data to the cloud game client.

For the foregoing S301, the cloud game client is first described. Herein, the cloud game client may be specifically a cloud game client corresponding to a new user under a target cloud game, or may be a cloud game client that plays a game under the target cloud game for a plurality of times. A gamer corresponding to the cloud game client is the user in embodiments of the present disclosure.

The cloud game client may run a plurality of cloud games, for example, the plurality of cloud games listed in FIG. 2. Optional cloud games may specifically relate to different game types, for example. a policy-typed game, such as a board game, a Sokoban game, or an elimination game, a battle-typed game, such as a monster hitting game or a shooting game, or an operation-typed game, such as a sports game like a billiard game.

Under the cloud game platform, a cloud game that is being run by the current cloud game client may be determined, and is referred to as a target cloud game in this embodiment of the present disclosure. The game state information of the target cloud game may be specifically expressed in a plurality of game description dimensions. For example, from the perspective of the cloud game, a current game phase or a type of game task being completed may be used to determine the game state information. From the perspective of a virtual game role selected to be acted by the user, a specific virtual game role that is currently selected, operation instructions that can be correspondingly selected, and remaining hit points of the virtual game role may also be used to determine the game state information. From the perspective of a rival of the virtual game role, such as a game monster role, a specific game monster role that the player faces and remaining hit points of the current game monster role may also be used to determine the game state information. Therefore, the game state information may summarize and describe in different dimensions according to actual situations, to describe a progress of the current cloud game and statuses of respective virtual roles of the game. Levels of details during specific summary and selected different perspectives may be determined according to actual situations. This is not limited herein.

For the foregoing S302, after the cloud game platform determines the game state information corresponding to the current running target cloud game, the cloud game platform may provide the at least one operation instruction set for the cloud game client by using the game state information.

Herein, when the operation instruction set is provided for the cloud game client, it is specifically expected to provide, an operation instruction that can complete the target cloud game, for the user. Therefore, for the operation instruction set provided herein, the operation instruction set matching the game state information is selected during specific selection. When the operation instruction set is obtained through recognition processing in an existing game video, the selected game operation video is referred to as the target game video in this embodiment of the present disclosure. The game operation result corresponding to the target game video herein meets the target condition. The target condition may basically include completing the present level or beating a virtual game monster, that is, completing a game task or passing the game, and may further include achieving a high score, quick completion, or the like. In some possible cases, such a target game video may also be referred as to a highlighted historical video.

The game operation video may be specifically obtained through recording by any user under the target cloud game when playing the target cloud game, or may be obtained from videos that may be authorized to be obtained. In a possible case, when the user runs the target cloud game or finishes running the target cloud game, the corresponding at least one operation instruction may be obtained, to form the operation instruction set. Specifically, the operation instruction may be recorded in the following two different manners. In one possible case, before the target cloud game is started, authorization of a user may be accepted to continuously record the operation instruction in a process of running the target cloud game. In the other possible case, after the target cloud game ends, the operation instruction triggered in the target cloud game may be collated and collected at one time through authorization of the user. Alternatively, another feasible manner may be used to record the operation instruction in the target cloud game, which is not listed one by one herein again.

In another possible case, in the foregoing solution, when an operation instruction of the game is retained, the corresponding operation instruction may further need to be maintained. Therefore, a large quantity of storage resources is occupied for storage. Therefore, in this embodiment of the present disclosure, a manner of determining the operation instruction set by performing operation instruction recognition processing on the target game video is further specifically provided.

During specific implementation, the operation instruction set may be obtained after the operation instruction recognition processing is performed on the target game video in the following manner: filtering in the target game video to obtain a plurality of key frames including a virtual game object; performing semantic recognition processing on the plurality of key frames, to determine object behavior information of the virtual game object; and generating the operation instruction set based on the object behavior information.

The following describes the foregoing manner in detail. First, for the target game video, a specific objective during recognition processing is to recognize and determine operation instructions that are specifically selected in a corresponding cloud game process when the game video is recorded this time, and different operation instructions may be specifically reflected in aspects such as actions, dialogs, generated effects and audio effects of a virtual game role controlled by the user and a virtual rival role in a video image. Therefore, for the foregoing different aspects, key frame filtering may be first performed on the target game video to obtain the plurality of key frames including the virtual game object (including the virtual game role and the virtual rival role).

Then, semantic recognition processing is performed on these key frames, and may specifically include processing the key frames and audio data corresponding to the key frames, to determine the object behavior information of the virtual game object. For example, a multimodal large language model (Multimodal Large Language Model, MLLM) may be used to perform image preprocessing of the key frames, and then recognize a corresponding operation description for the virtual game object therein. For example, semantic recognition processing is performed on the plurality of key frames, to determine that the virtual game role therein completes an action of advancing and fisting in the target cloud game under control of the operation instruction. In this case, the advancing and fisting action of the virtual game role is used as the object behavior information of the virtual game object.

Then, the operation instruction set may be generated by using the determined object behavior information of the virtual game object. Specifically, the object behavior information of the virtual game object may be analyzed by using expected results brought by operation instructions to the virtual game object under the target cloud game. For example, following the foregoing example, under the target cloud game, if it may be determined that an operation instruction 1 controls the virtual game role to complete an advancing action, and that an operation instruction 2 controls the virtual game role to complete a fisting action, based on the object behavior information of the virtual game object, i.e., an action of advancing and fisting, it can be easily obtained through matching that the operation instruction specifically includes the operation instruction I and the operation instruction 2, and it is determined that the corresponding operation instruction set is the operation instruction 1 and the operation instruction 2.

The foregoing merely provides an optional implementation, and other manners that can implement the same effect in light of the concept all also fall within the protection scope of this embodiment of the present disclosure, and are not listed and described one by one herein.

After obtaining the plurality of operation instruction sets obtained based on the plurality of target game videos, the cloud game platform may further specifically generate label information corresponding to each operation instruction set according to game-related data in the target game video.

Herein, the game-related data may specifically include a game event mark, game data, player data, a game score, and the like in the cloud game. For example, the game event mark may be used to identify a specific type of game task or a game phase of the target game video. The game data may be a damage value generated for the virtual rival role, or the like. The player data may include obtained game gains, a role state of the virtual game role, and the like. The game score may be a score obtained according to time for completing the game, and the like. Herein, because game content under different cloud games are different, specific game-related data changes according to different cloud games. Only a possible example is provided herein. When the label information is determined by using the game-related data, a piece of label information having features in a plurality of dimensions may be specifically obtained according to different dimensions of the game-related data.

In this way, when the cloud game platform indicates the foregoing obtained at least one operation instruction set to the cloud game client, a plurality of operation instruction sets and label information corresponding to the operation instruction sets may be indicated to the cloud game client. For the cloud game client, the label information may be specifically used to sort the plurality of operation instructions for display, or game-related data in some selected or all dimensions may be displayed to the user, for example, time for completing the cloud game is displayed, so that the user can select a required operation instruction set based on the displayed game-related data to complete the target cloud game.

Herein, for the foregoing described case of sorting the plurality of operation instruction sets by using the label information, in a possible case, the sorting task may also be completed by the cloud game platform.

During specific implementation, the cloud game platform may determine correlation scores respectively between the plurality of operation instruction sets and the game state information of the cloud game client according to the label information of the plurality of operation instruction sets; determine operation result scores of the plurality of operation instruction sets according to the label information of the plurality of operation instruction sets; and sort the plurality of operation instruction sets according to the correlation scores and the operation result scores, and indicate the plurality of sorted operation instruction sets and the label information respectively corresponding to the plurality of operation instruction sets to the cloud game client.

Herein, determining operation result scores of the plurality of operation instruction sets according to the label information is first described. The operation result score is specifically used to reflect operation quality of the operation instruction set for the target cloud game. The operation quality is reflected in whether the game can be quickly completed, or whether the game can be completed through simple operation instruction selection, or whether a high score can be achieved, or the like. When the operation result score is determined, weighted comprehensive calculation may be performed with reference to the foregoing plurality of dimensions for evaluating the operation quality, or only one dimension may be selected for calculation. This may be specifically determined based on a type of the target cloud game.

For example, for a battle-typed game, for example, monster hitting, whether a monster can be beaten as soon as possible and whether high game gains can be obtained are focused. Therefore, the operation result score may be determined by using data corresponding to the two dimensions under the label information. For a policy-typed board game, whether a game can be ended after fewer operations may be more focused. In this case, when the operation result score is determined, time used to complete the game and a quantity of operation instructions of reaction steps are more focused. The operation result score obtained herein will be used for players of the target cloud game to determine whether the listed operation instruction set can help them to pass the game task in the target cloud game.

However, in an actual target cloud game process, because game progresses of different people under the target cloud game are different, and selected virtual game objects and the like are also different, it is possible that an operation instruction that may be used by another user to pass the game under a historical game cannot be used for the target cloud game played by the user this time. This is because game states cannot completely match each other. Therefore, in addition to sorting the operation instruction sets based on the foregoing described operation result scores, correlation scores respectively between the plurality of operation instruction sets and the game state information of the cloud game client may be further determined, to perform comprehensive sorting.

Herein, when the correlation between the operation instruction set and the game state information is determined, for example, the correlation may be determined in the following plurality of determining manners: whether an operation instruction in the operation instruction set can be selected, whether the indicated virtual game role is consistent with the virtual game role currently selected by the user, and whether the virtual rival role that the virtual game role is against is consistent with the virtual rival role that the current virtual game role currently faces, and the like, in the case of the current game state of the cloud game client being reflected by the game state information.

For example, for a racing-typed cloud game, two operation instruction sets may be determined, which are respectively represented as an operation instruction set a and an operation instruction set b. According to label information respectively corresponding to the operation instruction set a and the operation instruction set b, it may be determined that a vehicle used under the operation instruction set a is a vehicle cl, and a vehicle used under the operation instruction set b is a vehicle c2. In this case, if it can be determined that the vehicle cl is selected under the game state information of the cloud game client, even if the vehicle c2 is similar to the vehicle cl, the correlation score of the operation instruction set a is higher than that of the operation instruction set b.

In this way, the correlation scores can be determined by using the label information, and then sorting of the operation instruction sets is comprehensively determined according to the operation result scores. In some possible examples, if an operation result score of an operation instruction set is quite high, but a correlation score of the operation instruction set is low, for example, racing time is quite short, but this is specifically because performance of the selected vehicle is quite different from vehicle performance when the cloud game is currently played under the cloud game client, such an operation instruction set is not suitable for preferential recommendation, and is not displayed at a front position for preferential display after comprehensive sorting.

In this way, the cloud game platform may sort the plurality of operation instruction sets according to the correlation scores and the operation result scores, and indicate the plurality of sorted operation instruction sets and the label information respectively corresponding to the plurality of operation instruction sets to the cloud game client.

The cloud game client may display the received at least one operation instruction set, so that the user can select the target operation instruction set from the at least one operation instruction set to play the target cloud game, or to preview.

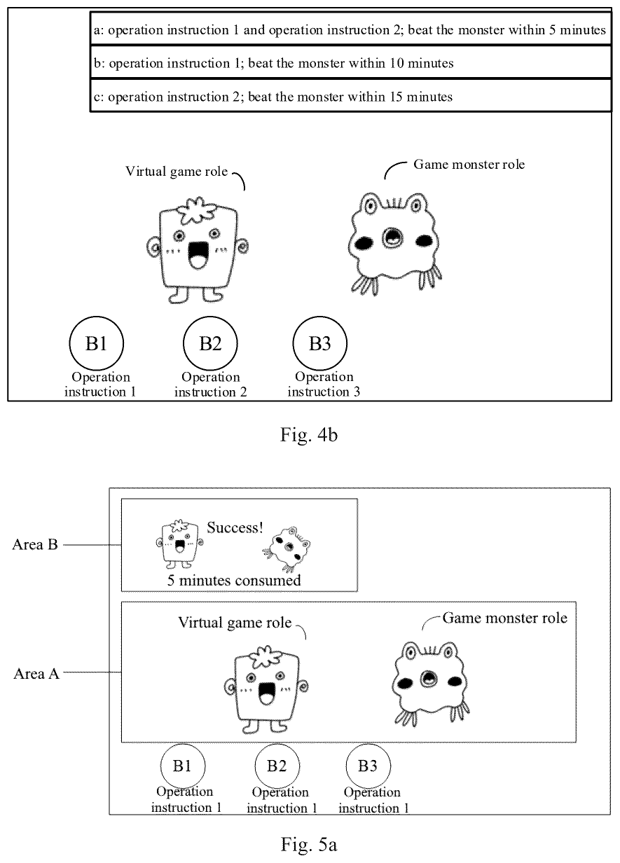

For example, FIG. 4a is a schematic diagram of a plurality of displayed operation instruction sets according to an embodiment of the present disclosure. A main image in the figure displays a virtual game role controlled by the user and a game monster role that the virtual game role currently faces. Optional operation instructions, including control buttons B1, B2, and B3 that respectively correspond to an operation instruction 1, an operation instruction 2, and an operation instruction 3 are displayed at the lower left corner of the image. A plurality of operation instruction sets respectively numbered a, b, and c are displayed at the upper right corner of the image. Using the operation instruction set numbered a as an example, the operation instruction set specifically includes two recommended instructions, including the operation instruction 1 and the operation instruction 2.

Herein, when the plurality of operation instruction sets are displayed, some information in the label information may also be displayed. For example, a user name provided through authorization of a user who provides the operation instruction set may be displayed, or a game record achieved by using the operation instruction set may be displayed, so that the user may further refer to the information, to select a suitable target operation instruction set.

For example, FIG. 4b is another schematic diagram of a plurality of displayed operation instruction sets according to an embodiment of the present disclosure. In comparison with that only information such as numbers of the operation instruction sets and operation instructions therein is displayed in FIG. 4a, historical game recorded information is further displayed. For example, historical game recorded information corresponding to the operation instruction set with the number a is specifically “beat the monster within 5 minutes”.

After the cloud game client displays an operation list, the user may select an operation instruction set therein. Herein, selecting the operation instruction set specifically relates to different manners. In one manner, the selected operation instruction set is used in a cloud game currently played by the user. In the other manner, the selected operation instruction set is used to enable the user to perform split-screen game preview.

The following separately describes the foregoing two different cases.

First, for the first case, the user may select any operation instruction set from the operation list, and use the operation instruction set in the currently played cloud game. In response to selecting the target operation instruction set in the at least one operation instruction set, the cloud game client may indicate the target operation instruction set to the cloud game platform.

Herein, to distinguish between two different cases of selecting the operation instruction set, discriminate settings of the selection operation may be performed in advance. For example, under a single-tap selection operation, it is determined that the target operation instruction set selected by the user acts on the cloud game currently played, and under a double-tap selection operation, a corresponding operation intention is to perform result preview of an operation instruction.

When it is determined to act the target operation instruction set on the currently played cloud game, specifically corresponding to the foregoing step S303, the cloud game platform may indicate the target instruction set to the cloud game running end. The cloud game running end may determine an instruction execution result in the cloud game according to the target instruction set, and feed back a corresponding post-operation game image data to the cloud game platform. After obtaining the post-operation game image data that is fed back by the cloud game running end, the cloud game platform transmits the post-operation game image data back to the cloud game client. The cloud game client displays a post-operation game image to the user according to the post-operation game image data that is fed back by the cloud game running end.

Second, for the second case, when it is determined to preview a selection operation indication of the target operation instruction set, in response to a preview instruction for the operation instruction set in the operation list, the cloud game client may specifically obtain preview image data fed back by the cloud game platform in response to the preview instruction; and display, outside a current game image, a game preview image corresponding to the preview image data.

Alternatively, in response to synchronous preview instructions for the plurality of operation instruction sets in the operation list, preview image data generated by the cloud game platform respectively for the plurality of synchronous preview instructions is obtained, and game preview images respectively corresponding to the plurality of pieces of preview image data are synchronously displayed outside a current game image.

In other words, when selecting a game image affected by the operation instruction set for preview, the user may select one or more game images for preview.

In specific implementation, the preview image data may be obtained in the following manner: obtaining mixed flow image data obtained by performing flow mixing processing on the preview image data and current game image data by the cloud game platform.

The following describes a specific manner in which the cloud game platform feeds back mixed flow image data according to an operation instruction set selected by the user.

First, in response to receiving a preview instruction of the cloud game client for any operation instruction set in the operation list, the cloud game platform may determine the preview image data corresponding to the preview instruction, perform flow mixing processing on the preview image data and the current game image data, and feed back the mixed flow image data obtained after the flow mixing processing to the cloud game client.

In other words, after receiving the preview instruction for any operation instruction set, the cloud game client may feed back the preview instruction or the operation instruction set indicated by the preview instruction to the cloud game platform, so that the cloud game platform can obtain the preview image data on this basis. Herein, the preview image data may be specifically result data fed back by the cloud game running end after the cloud game platform sends the operation instruction set to the cloud game running end, in which the process is similar to a corresponding process when the user plays the cloud game as described above.

In this way, the cloud game platform may obtain image data from the cloud game running end, where the image data specifically includes a post-operation game image obtained when the cloud game is played, and preview image data obtained for the preview instruction.

To enable the user to synchronously watch the game image of the cloud game, and the preview image corresponding to the selected operation instruction set, when sending the game image to the cloud game client, the cloud game platform may specifically select to perform flow mixing processing on the preview image data and the current game image, and feed back the mixed flow image data obtained after the flow mixing processing to the cloud game client.

Second, if the instruction received by the cloud game platform is a synchronous preview instruction, that is, the user specifically selects a plurality of operation instruction sets from the operation list for synchronous preview, in response to receiving the synchronous preview instruction of the cloud game client for the plurality of operation instruction sets in the operation list, the cloud game platform determines preview image data separately corresponding to each synchronous preview instruction, performs flow mixing processing on the plurality of pieces of preview image data and the current game image data, and feeds back the mixed flow image data obtained after the flow mixing processing to the cloud game client.

This is different from the foregoing embodiment in that, when it is determined that there are a plurality of selected operation instruction sets and preview display is performed, a plurality of pieces of preview image data during flow mixing are specifically included. During flow mixing processing, due to increasing image data on which flow mixing processing is to be performed, different flow mixing manners may be correspondingly used.

A specific function of flow mixing described herein is to transmit a plurality of images together, rather than transmit the images one by one in sequence, or schedule a plurality of interfaces to respectively transmit different images. Therefore, beneficial effects of synchronous transmission and reducing interface occupation can be specifically achieved.

After performing flow mixing processing on the preview image data, the cloud game platform may send the mixed flow image data obtained after flow mixing processing to the cloud game client. After receiving the mixed flow image data, the cloud game client may display the current game image and at least one game preview image.

In specific implementation, the cloud game client may specifically display the game preview image in the following manner: dividing a game display page into a plurality of display areas based on a quantity of game images corresponding to the mixed flow image data, and displaying the current game image and the at least one game preview image respectively in the plurality of display areas.

For ease of understanding, the following provides description by using examples. Corresponding to the foregoing two cases of performing operation and preview, in a possible case, there is only one operation instruction set for preview. In this case, the current game image is included, and the mixed flow image data specifically includes two game images, that is, the quantity of game images is “2”. In this case, the game display page may be divided into one area for displaying the current game image and one area for displaying the game preview image, to respectively display the two game images.

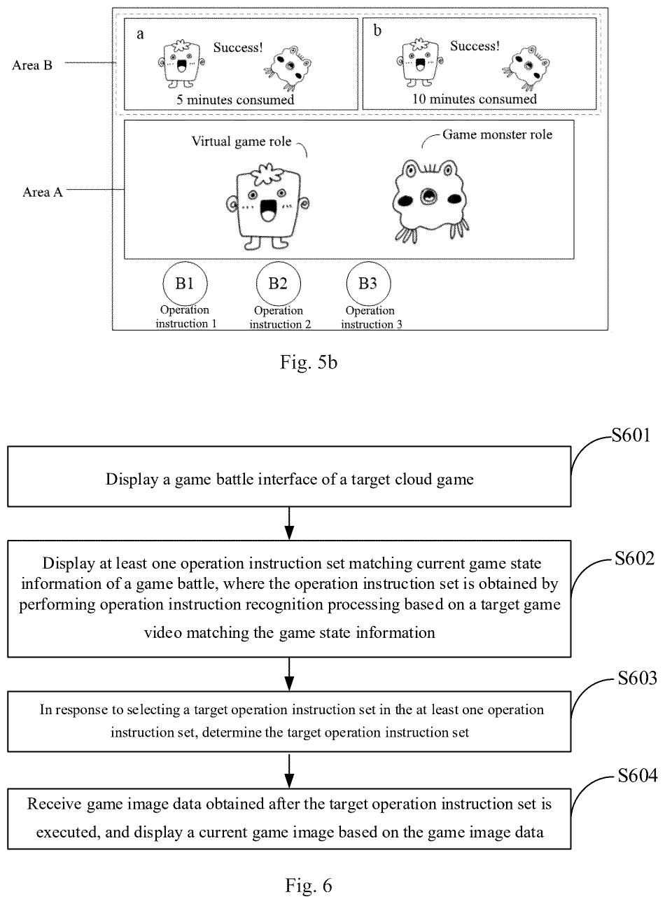

For example, FIG. 5a is a schematic diagram of previewing a game preview image under one operation instruction set according to an embodiment of the present disclosure. The schematic diagram includes the area for displaying the current game image, which is denoted as an area A; and the area for displaying the game preview image at an associated position, which is denoted as an arca B.

In another possible case, there are a plurality of, for example, 2 operation instruction sets for preview. In this case, the current game image is included, and the mixed flow image data specifically includes three game images, that is, the quantity of game images is “3”. In this case, the game display page may still be divided into one area for displaying the current game image and one area for displaying the game preview image, and the area for displaying the game preview image is divided according to a quantity of selected operation instruction sets, to display game preview images corresponding to the operation instruction sets correspondingly.

For example, FIG. 5b is a schematic diagram of previewing game preview images under a plurality of operation instruction sets according to an embodiment of the present disclosure. The schematic diagram includes the area for displaying the current game image, which is denoted as an area A; and the area for displaying the game preview image at an associated position, which is denoted as an area B. The area B specifically displays game preview images corresponding to two selected operation instruction sets. In addition, for case of differentiation, reference numerals of operation instruction sets and the like may be specifically selected to perform differentiated annotation on images.

In this way, the cloud game client may display the current game image and at least one game preview image.

The following describes, by using an example in which the execution body is the cloud game client, a cloud game operation control method provided in embodiments of the present disclosure. Herein, the cloud game client may be specifically a cloud game client corresponding to a new user under a target cloud game, or may be a cloud game client that plays a game under the target cloud game for a plurality of times. A gamer corresponding to the cloud game client is the user in embodiments of the present disclosure.

FIG. 6 is a flowchart of another cloud game operation control method according to an embodiment of the present disclosure. The method is applicable to a cloud game client, and includes steps S601 to S604.
S601: Display a game battle interface of a target cloud game.
S602: Display at least one operation instruction set matching current game state information of a game battle, where the operation instruction set is obtained by performing operation instruction recognition processing based on a target game video matching the game state information.
S603: In response to selecting a target operation instruction set in the at least one operation instruction set, determine the target operation instruction set.
S604: Receive game image data obtained after the target operation instruction set is executed, and display a current game image based on the game image data.

For details of the foregoing steps, reference may be made to corresponding descriptions in the foregoing embodiment. Details are not described herein again, and only brief descriptions are provided herein.

For the foregoing S601, display of the game battle page under the target cloud game is specifically provided for the user in the cloud game client. In the game battle page, an image of the game being played may be specifically displayed, an operation identifier corresponding to an operation instruction and the like can be selected by the user, and other information related to the user or the cloud game, for example, user information may also be displayed.

For the foregoing S602, in the game battle page, the at least one operation instruction set matching the current game state information of the game battle may be specifically displayed. According to the descriptions of the foregoing embodiment, the operation instruction set may be specifically obtained by performing speech recognition on the target game video. The target game video is a game operation video, a corresponding game operation result of which meets a target condition. For descriptions of the target condition, reference may be made to the foregoing embodiment for details.

Specifically, the obtained target game video includes a plurality of key frames of a virtual game object under the cloud game, and actions, fighting effects, and the like corresponding to the virtual game object that are displayed on these key frames may reflect a control instruction specifically selected by the virtual game object.

On this basis, by performing semantic recognition on the plurality of key frames including the virtual game object, object behavior information of the virtual game object, for example, a beating action of the virtual game object, can be obtained, and an operation instruction set specifically selected under the target game video can be determined according to a correspondence that is between the beating action and the operation instruction and that can be predetermined.

In specific implementation, when the at least one operation instruction set matching the current game state information of the game battle is displayed, the at least one operation instruction set, and label information corresponding to each operation instruction set may be specifically displayed, where the label information indicates game attribute information corresponding to the operation instruction set, and the game attribute information is used by a user for reference to select the target operation instruction set.

Herein, the label information may specifically implement a function of marking the operation instruction sets, and may provide selection reference for the user by using information expressed by the label information. Specifically, the label information may be determined by using the game attribute information. The game attribute information herein may specifically include information that expresses game completion degree such as game passing duration and game gains, and may also include icon information that expresses a specific action such as steering and jumping, and the like. For example, a steering icon is used to identify a function of a particular operation instruction set as implementing vehicle steering, or by marking “game passing duration: within 5 minutes”, it is identified that a particular operation instruction set may be used to enable the game goal to be achieved within 5 minutes of the cloud game. Therefore, the user may have reference for selection from a plurality of operation instruction sets by using the corresponding label information.

For the foregoing S603, the user may specifically select one or more from the plurality of displayed operation instruction sets as the target operation instruction set. The selected target operation instruction set is an operation instruction set used to complete the game under the cloud game. After confirming the target operation instruction set selected by the user, the cloud game client sends the target operation instruction set to the cloud game platform, the cloud game platform feeds back the target operation instruction set to the cloud game running end, and then the cloud game platform returns, to the client game client, video stream data determined by the cloud game running end according to the target operation instruction set, so that the user can watch the game image.

In this way, for the foregoing S604, the cloud game client may receive the game image data obtained after the target operation instruction set is executed, and display a current game image based on the game image data. Herein, the plurality of operation instruction sets provided by the cloud game platform may be specifically selected for preview. To be specific, as described in the foregoing embodiment, game preview images respectively corresponding to the selected operation instruction sets are synchronously displayed outside the current game image.

Herein, for a manner of obtaining the preview image data and a manner of specifically displaying the game preview image, reference may be made to specific descriptions in the foregoing embodiment for details. Details are not described herein again.

By using the cloud game operation control method provided in this embodiment of the present disclosure, the cloud game platform may provide, according to the game state information when the target cloud game is currently run, the operation instruction set matching the current game state information for the cloud game client. Herein, the operation instruction set is obtained by performing operation instruction recognition processing according to the target game video matching the game state information. For example, when there is a historical game video in which another user passes the game in a similar game state, recognition processing may be performed on the historical game video to obtain an operation instruction set selected when the game was completed. In this way, gamers may refer to and select these operation instruction sets that are expected to pass the game, to quickly complete the same, and do not need to select, by themselves, different operation instructions and making a plurality of game attempts repetitively, so that the interactive trial-and-error costs are reduced while the gamers normally perform game interaction, thereby improving interactive experience.

A person skilled in the art may understand that, in the foregoing methods of specific implementations, the order in which the steps are written does not means a strict order of execution, and does not constitute any limitation on the implementation process, and the specific order of execution of the steps should be determined by functions and possible internal logic of the steps.

Based on a same inventive concept applicable to a cloud game platform, an embodiment of the present disclosure further provides a cloud game operation control apparatus corresponding to the cloud game operation control method. Because the apparatus in this embodiment of the present disclosure resolves the problem in a principle similar to that of the foregoing cloud game operation control method in embodiments of the present disclosure, for the implementation of the apparatus, reference may be made to the implementation of the method, and repetitions are not described again.

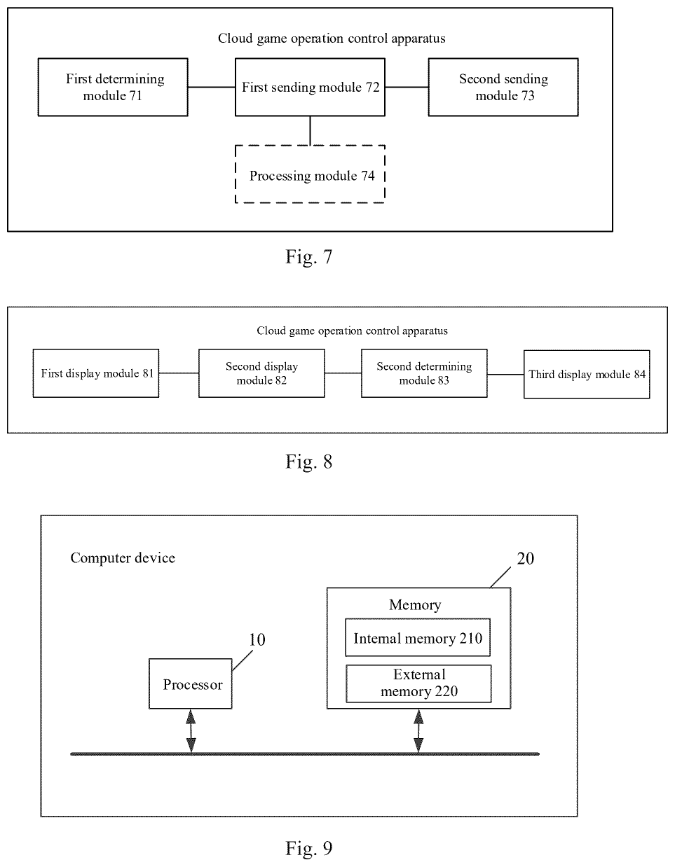

FIG. 7 shows a cloud game operation control apparatus according to an embodiment of the present disclosure. The apparatus is applicable in a cloud game platform, and includes: a first determining module 71, a first sending module 72, and a second sending module 73.

The first determining module 71 is configured to determine game state information of a target cloud game currently running in a cloud game client.

The first sending module 72 is configured to: determine, based on the game state information, at least one operation instruction set matching the game state information, and indicate the at least one operation instruction set to the cloud game client, where the operation instruction set is obtained by performing operation instruction recognition processing based on a target game video matching the game state information, and the target game video is a game operation video, a corresponding game operation result of which meets a target condition.

The second sending module 73 is configured to: in response to receiving a selected target operation instruction set fed back by the cloud game client, generate game image data obtained after the cloud game client correspondingly executes the target operation instruction set, and send the game image data to the cloud game client.

In an optional implementation, the operation instruction set is obtained by performing the operation instruction recognition processing on the target game video in the following manner: filtering in the target game video to obtain a plurality of key frames including a virtual game object; performing semantic recognition processing on the plurality of key frames, to determine object behavior information of the virtual game object; and generating the operation instruction set based on the object behavior information.

In an optional implementation, the apparatus further includes a processing module 74, configured to: after obtaining a plurality of operation instruction sets based on a plurality of target game videos. generate label information corresponding to each operation instruction set according to game-related data in the target game video; and when indicating the at least one operation instruction set to the cloud game client, the first sending module 72 is configured to indicate the plurality of operation instruction sets and label information respectively corresponding to the plurality of operation instruction sets to the cloud game client.

In an optional implementation, when indicating the plurality of operation instruction sets and label information respectively corresponding to the plurality of operation instruction sets to the cloud game client, the first sending module 72 is configured to: determine correlation scores respectively between the plurality of operation instruction sets and the game state information of the cloud game client according to the label information of the plurality of operation instruction sets; determine operation result scores of the plurality of operation instruction sets according to the label information of the plurality of operation instruction sets; and sort the plurality of operation instruction sets according to the correlation scores and the operation result scores, and indicate the plurality of sorted operation instruction sets and the label information respectively corresponding to the plurality of operation instruction sets to the cloud game client.

In addition, applicable to a cloud game platform, an embodiment of the present disclosure further provides a cloud game operation control apparatus corresponding to the cloud game operation control method. Because the apparatus in this embodiment of the present disclosure resolves the problem based on a principle similar to that of the foregoing cloud game operation control method in embodiments of the present disclosure, for the implementation of the apparatus, reference may be made to the implementation of the method, and repetitions are not described again.

FIG. 8 shows a cloud game operation control apparatus according to an embodiment of the present disclosure. The apparatus is applicable in a cloud game client, and includes: a first display module 81, a second display module 82, a second determining module 83, and a third display module 84.

The first display module 81 is configured to display a game battle interface of a target cloud game.

The second display module 82 is configured to display at least one operation instruction set matching current game state information of a game battle, where the operation instruction set is obtained by performing operation instruction recognition processing based on a target game video matching the game state information.

The second determining module 83 is configured to: in response to selecting a target operation instruction set in the at least one operation instruction set, determine the target operation instruction set.

The third display module 84 is configured to: receive game image data obtained after the cloud game client executes the target operation instruction set, and display a current game image based on the game image data.

In an optional implementation, the operation instruction set is generated by using object behavior information of a virtual game object obtained through recognition after semantic recognition is performed on a plurality of key frames of the virtual game object included in the target game video; and the target game video is a game operation video, a corresponding game operation result of which meets a target condition.

In an optional implementation, when displaying the at least one operation instruction set matching the current game state information of the game battle, the first display module 81 is configured to: display the at least one operation instruction set, and label information corresponding to each operation instruction set, where the label information indicates game attribute information corresponding to the operation instruction set, and the game attribute information is used by a user for reference to select the target operation instruction set.

In an optional implementation, after displaying the at least one operation instruction set, the second display module 82 is further configured to: in response to a preview instruction for any operation instruction set, obtain preview image data fed back in response to the preview instruction; and display, outside a current game image, a game preview image corresponding to the preview image data.

In an optional implementation, after displaying the at least one operation instruction set, the second display module 82 is further configured to: in response to a synchronous preview instruction for the plurality of operation instruction sets, obtain preview image data separately generated in response to the synchronous preview instruction: and synchronously display, outside a current game image, game preview images respectively corresponding to the plurality of pieces of preview image data.

In an optional implementation, the preview image data is obtained according to the following steps: obtaining mixed flow image data obtained by performing flow mixing processing on the preview image data and current game image data; and when displaying the game preview image, the second display module 82 is configured to: divide a game display page into a plurality of display areas based on a quantity of game images corresponding to the mixed flow image data, and display the current game image and the at least one game preview image respectively in the plurality of display areas.

Reference may be made to related descriptions in the foregoing method embodiment for descriptions of processing procedures of the modules in the apparatus, and procedures of interactions between the modules.

An embodiment of the present disclosure further provides a computer device. FIG. 9 is a schematic structural diagram of a computer device according to an embodiment of the present disclosure. The computer device includes:
a processor 10 and a memory 20, where the memory 20 stores a machine-readable instruction that can be executed by the processor 10, the processor 10 is configured to execute the machine-readable instruction stored in the memory 20, and when the machine-readable instruction is executed by the processor 10, the processor 10 performs the following steps:
determining game state information of a target cloud game currently running in a cloud game client; determining, based on the game state information, at least one operation instruction set matching the game state information, and indicating the at least one operation instruction set to the cloud game client, where the operation instruction set is obtained by performing operation instruction recognition processing based on a target game video matching the game state information, and the target game video is a game operation video, a corresponding game operation result of which meets a target condition; and in response to receiving a selected target operation instruction set fed back by the cloud game client, generating game image data obtained after the cloud game client correspondingly executes the target operation instruction set, and sending the game image data to the cloud game client.

Alternatively, the processor 10 performs the following steps:
displaying a game battle interface of a target cloud game; displaying at least one operation instruction set matching current game state information of a game battle, where the operation instruction set is obtained by performing operation instruction recognition processing based on a target game video matching the game state information; and in response to selecting a target operation instruction set in the at least one operation instruction set, determining the target operation instruction set; and receiving game image data obtained after the target operation instruction set is executed, and displaying a current game image based on the game image data.

The memory 20 includes an internal memory 210 and an external memory 220. The internal memory 210 herein is also referred to an inner memory, and is configured to temporarily store operational data in the processor 10, and data exchanged with the external memory 220 such as a hard disk. The processor 10 exchanges data with the external memory 220 by using the internal memory 210.

For a specific execution process of the foregoing instruction, reference may be made to the steps of the cloud game operation control method in embodiments of the present disclosure. Details are not described herein again.

An embodiment of the present disclosure further provides a computer-readable storage medium, where the computer-readable storage medium stores a computer program, and when the computer program is run by a processor, the steps of the cloud game operation control method in the forgoing method embodiments are performed. The storage medium may be a volatile or non-volatile computer-readable storage medium.

An embodiment of the present disclosure further provides a computer program product. The computer program product carries program code. Instructions included in the program code may be used to perform the steps of the cloud game operation control method in the foregoing method embodiments. Reference may be made to the foregoing method embodiments for details. Details are not described herein again.

The above computer program product may be implemented by hardware, software or a combination thereof. In an alternative embodiment, the computer program product is embodied as a computer storage medium, and in another alternative embodiment, the computer program product is embodied as a software product, such as a Software Development Kit (SDK) and the like.

It can be clearly understood by those skilled in the art that for the convenience and conciseness of description, the specific working process of the system and device described above may refer to the corresponding process in the aforementioned method embodiment, and will not be repeated here. In several embodiments provided by this disclosure, it should be understood that the disclosed systems, devices and methods may be implemented in other ways. The device embodiments described above are only schematic. For example, the division of the units is only a logical function division, and there may be another division method in actual implementation. For example, multiple units or components may be combined or integrated into another system, or some features may be ignored or not implemented. On the other hand, the mutual coupling or direct coupling or communication connection shown or discussed may be indirect coupling or communication connection through some communication interfaces, devices or units, which may be in electrical, mechanical or other forms.

The units described as separate components may or may not be physically separated, and the components displayed as units may or may not be physical units, that is, they may be located in one place or distributed to multiple network units. Some or all of the units can be selected according to actual needs to achieve the purpose of this embodiment.

In addition, each functional unit in each embodiment of the present disclosure may be integrated into one processing unit, or each unit may exist physically alone, or two or more units may be integrated into one unit.

If the functions are implemented in the form of software functional units and sold or used as independent products, they can be stored in a processor-executable nonvolatile computer-readable storage medium. Based on this understanding, the technical solution of the present disclosure can be embodied in the form of a software product, which is stored in a storage medium and includes several instructions to make a computer device (which can be a personal computer, a server, a network device, etc.) execute all or part of the steps of the method described in various embodiments of the present disclosure. The aforementioned storage media include: U disk, mobile hard disk, Read-Only Memory (ROM), Random Access Memory (RAM), magnetic disk or optical disk and other media that can store program codes.

Finally, it should be explained that the above-mentioned embodiments are only specific embodiments of the disclosure, which are used to illustrate the technical solutions of the disclosure, but not to limit it. The scope of the disclosure is not limited to this. Although the disclosure has been described in detail with reference to the above-mentioned embodiments, it should be understood by ordinary people in the field that any person familiar with the technical field can still modify or easily think of changes to the technical solutions recorded in the above-mentioned embodiments within the technical scope of the disclosure, or make equivalent substitutions for some technical features therein. However, these modifications, changes or substitutions do not make the essence of the corresponding technical solution deviate from the spirit and scope of the technical solution of the embodiments of this disclosure. and should be included in the scope of this disclosure. Therefore, the scope of this disclosure should be based on the scope of the claims.

1. A cloud game operation control method, applicable to a cloud game platform and comprising:
determining game state information of a target cloud game currently running in a cloud game client;
determining, based on the game state information, at least one operation instruction set matching the game state information, and indicating the at least one operation instruction set to the cloud game client, the operation instruction set being obtained by performing operation instruction recognition processing based on a target game video matching the game state information, and the target game video being a game operation video, a corresponding game operation result of which meets a target condition; and
in response to receiving a selected target operation instruction set fed back by the cloud game client, generating game image data obtained after the cloud game client correspondingly executes the selected target operation instruction set, and sending the game image data to the cloud game client.

2. The method according to claim 1, wherein the operation instruction set is obtained by performing the operation instruction recognition processing on the target game video in a following manner:
filtering in the target game video to obtain a plurality of key frames comprising a virtual game object;
performing semantic recognition processing on the plurality of key frames, to determine object behavior information of the virtual game object; and
generating the operation instruction set based on the object behavior information.

3. The method according to claim 1, further comprising:
after obtaining a plurality of operation instruction sets based on a plurality of target game videos, generating label information corresponding to each operation instruction set according to game-related data in the target game video; and
the indicating the at least one operation instruction set to the cloud game client comprises:
indicating the plurality of operation instruction sets and the label information respectively corresponding to the plurality of operation instruction sets to the cloud game client.

4. The method according to claim 3, wherein the indicating the plurality of operation instruction sets and the label information respectively corresponding to the plurality of operation instruction sets to the cloud game client comprises:
determining correlation scores respectively between the plurality of operation instruction sets and the game state information of the cloud game client according to the label information of the plurality of operation instruction sets;
determining operation result scores of the plurality of operation instruction sets according to the label information of the plurality of operation instruction sets; and
sorting the plurality of operation instruction sets according to the correlation scores and the operation result scores, and indicating the plurality of sorted operation instruction sets and the label information respectively corresponding to the plurality of operation instruction sets to the cloud game client.

5. A cloud game operation control method, applicable to a cloud game client and comprising:
displaying a game battle interface of a target cloud game;
displaying at least one operation instruction set matching current game state information of a game battle, the operation instruction set being obtained by performing operation instruction recognition processing based on a target game video matching the game state information;
in response to selecting a target operation instruction set in the at least one operation instruction set, determining the target operation instruction set; and
receiving game image data obtained after the target operation instruction set is executed, and displaying a current game image based on the game image data.

6. The method according to claim 5, wherein the operation instruction set is generated by using object behavior information of a virtual game object obtained through recognition after semantic recognition is performed on a plurality of key frames of the virtual game object included in the target game video; and
the target game video is a game operation video, a corresponding game operation result of which meets a target condition.

7. The method according to claim 5, wherein the displaying at least one operation instruction set matching current game state information of a game battle comprises:
displaying the at least one operation instruction set, and label information corresponding to each operation instruction set, wherein the label information indicates game attribute information corresponding to the operation instruction set, and the game attribute information is used by a user for reference to select the target operation instruction set.

8. The method according to claim 5, wherein after the displaying the at least one operation instruction set, the method further comprises:
in response to a preview instruction for any operation instruction set, obtaining preview image data fed back in response to the preview instruction; and
displaying, outside a current game image, a game preview image corresponding to the preview image data.

9. The method according to claim 5, wherein after the displaying the at least one operation instruction set, the method further comprises:
in response to a synchronous preview instruction for the plurality of operation instruction sets, obtaining preview image data separately generated in response to the synchronous preview instruction; and
synchronously displaying, outside a current game image, game preview images respectively corresponding to the plurality of pieces of preview image data.

10. The method according to claim 8, wherein the preview image data is obtained according to the following steps:
obtaining mixed flow image data obtained by performing flow mixing processing on the preview image data and current game image data; and
the displaying the game preview image, comprising:
dividing a game display page into a plurality of display areas based on a quantity of game images corresponding to the mixed flow image data, and displaying the current game image and at least one of the game preview images respectively in the plurality of display areas.

11-12. (canceled)

13. A computer device, comprising: at least one processor and a memory, wherein the memory stores a machine-readable instruction that can be executed by the processor, the processor is configured to execute the machine-readable instruction stored in the memory, and when the machine-readable instruction is executed by the processor, the processor performs a cloud game operation control method, which is applicable to a cloud game platform, and comprises:
determining game state information of a target cloud game currently running in a cloud game client;
determining, based on the game state information, at least one operation instruction set matching the game state information, and indicating the at least one operation instruction set to the cloud game client, the operation instruction set being obtained by performing operation instruction recognition processing based on a target game video matching the game state information, and the target game video being a game operation video, a corresponding game operation result of which meets a target condition; and
in response to receiving a selected target operation instruction set fed back by the cloud game client, generating game image data obtained after the cloud game client correspondingly executes the selected target operation instruction set, and sending the game image data to the cloud game client.

14. (canceled)

15. The method according to claim 2, further comprising:
after obtaining a plurality of operation instruction sets based on a plurality of target game videos, generating label information corresponding to each operation instruction set according to game-related data in the target game video; and
the indicating the at least one operation instruction set to the cloud game client comprises:
indicating the plurality of operation instruction sets and the label information respectively corresponding to the plurality of operation instruction sets to the cloud game client.

16. The method according to claim 15, wherein the indicating the plurality of operation instruction sets and the label information respectively corresponding to the plurality of operation instruction sets to the cloud game client comprises:
determining correlation scores respectively between the plurality of operation instruction sets and the game state information of the cloud game client according to the label information of the plurality of operation instruction sets;
determining operation result scores of the plurality of operation instruction sets according to the label information of the plurality of operation instruction sets; and
sorting the plurality of operation instruction sets according to the correlation scores and the operation result scores, and indicating the plurality of sorted operation instruction sets and the label information respectively corresponding to the plurality of operation instruction sets to the cloud game client.

17. The method according to claim 6, wherein the displaying at least one operation instruction set matching current game state information of a game battle comprises:
displaying the at least one operation instruction set, and label information corresponding to each operation instruction set, wherein the label information indicates game attribute information corresponding to the operation instruction set, and the game attribute information is used by a user for reference to select the target operation instruction set.

18. The method according to claim 9, wherein the preview image data is obtained according to the following steps:
obtaining mixed flow image data obtained by performing flow mixing processing on the preview image data and current game image data; and
the synchronously displaying, outside a current game image, game preview images respectively corresponding to the plurality of pieces of preview image data, comprising:
dividing a game display page into a plurality of display areas based on a quantity of game images corresponding to the mixed flow image data, and displaying the current game image and at least one of the game preview images respectively in the plurality of display areas.

19. The computer device according to claim 13, wherein the operation instruction set is obtained by performing the operation instruction recognition processing on the target game video in a following manner:
filtering in the target game video to obtain a plurality of key frames comprising a virtual game object;
performing semantic recognition processing on the plurality of key frames, to determine object behavior information of the virtual game object; and
generating the operation instruction set based on the object behavior information.

20. The computer device according to claim 13, the processor further performs:
after obtaining a plurality of operation instruction sets based on a plurality of target game videos, generating label information corresponding to each operation instruction set according to game-related data in the target game video; and
the indicating the at least one operation instruction set to the cloud game client comprises:
indicating the plurality of operation instruction sets and the label information respectively corresponding to the plurality of operation instruction sets to the cloud game client.

21. The computer device according to claim 19, the processor further performs:
after obtaining a plurality of operation instruction sets based on a plurality of target game videos, generating label information corresponding to each operation instruction set according to game-related data in the target game video; and
the indicating the at least one operation instruction set to the cloud game client comprises:
indicating the plurality of operation instruction sets and label information respectively corresponding to the plurality of operation instruction sets to the cloud game client.

22. The computer device according to claim 20, wherein the indicating the plurality of operation instruction sets and the label information respectively corresponding to the plurality of operation instruction sets to the cloud game client comprises:
determining correlation scores respectively between the plurality of operation instruction sets and the game state information of the cloud game client according to the label information of the plurality of operation instruction sets;
determining operation result scores of the plurality of operation instruction sets according to the label information of the plurality of operation instruction sets; and
sorting the plurality of operation instruction sets according to the correlation scores and the operation result scores, and indicating the plurality of sorted operation instruction sets and the label information respectively corresponding to the plurality of operation instruction sets to the cloud game client.

23. A computer device, comprising: at least one processor and a memory, wherein the memory stores a machine-readable instruction that can be executed by the processor, the processor is configured to execute the machine-readable instruction stored in the memory, and when the machine-readable instruction is executed by the processor, the processor performs the cloud game operation control method according to claim 5.
